(19) United States
(12) Patent Application Publication
(10) Pub. No.: US 2015/0014346 A1
(43) Pub. Date: Jan. 15, 2015

(54) DISPENSING DEVICE IN VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YUN-LUNG CHEN, New Taipei (TW); LI TONG, Wuhan (CN); WEI-YONG MA, Wuhan (CN); CHUAN LIN, Wuhan (CN); JIANG-FENG JIAO, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/262,957

(22) Filed: Apr. 28, 2014

(30) Foreign Application Priority Data
Jul. 9, 2013 (CN) 201310285807X

(51) Int. Cl. G07F 11/00

(52) U.S. Cl. CPC G07F 11/005
USPC 221/152

(57) ABSTRACT

A dispensing device for a vending machine includes a frame, a base plate, a limiting member attached to the frame, and a pivot shaft. When supported, the base plate carries a product item but when the support is rotated away the base plate drops to release the product item. The frame includes a main plate and a pair of mounting pieces with mounting holes. The base plate includes a pivot hole for the pivot shaft, the pivot shaft includes a rod, extending though the mounting hole and the pivot hole, and a limiting cap, connected to a distal end of the rod. An inner side of the limiting cap resists against the mounting piece. A resisting post on the limiting member resists against an outer side of the limiting cap, thereby preventing the pivot shaft from working loose and disengaging out of the mounting hole.

### FIELD

The present disclosure relates to vending machines, and particularly to a dispensing device in vending machines.

### BACKGROUND

Many dispensing assemblies for dispensing products includes a bracket, a tray, and a shaft. The bracket includes a base for placing the products thereon. The base is pivotably attached to the bracket by a pivot rod. The tray is located under the base. The tray is secured to the shaft. The shaft and tray support the base and the shaft is rotatable, to rotate the tray to release the base. As long as the tray is supporting the base, the products are blocked by the base and cannot be released. When the tray releases the base, the base is free, allowing one product item to drop down for the customer.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a dispensing device.

FIG. 2 is another exploded view of a first frame, a pair of pivot shafts, a pair of limiting members, and a base plate of the dispensing device of FIG. 1.

FIG. 3 is another view of one limiting member of FIG. 2.

FIG. 4 is similar to FIG. 3, but viewed from a different aspect.

FIG. 5 is an assembled view of the first frame, the pair of pivot shafts, the pair of limiting members, and the base plate of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

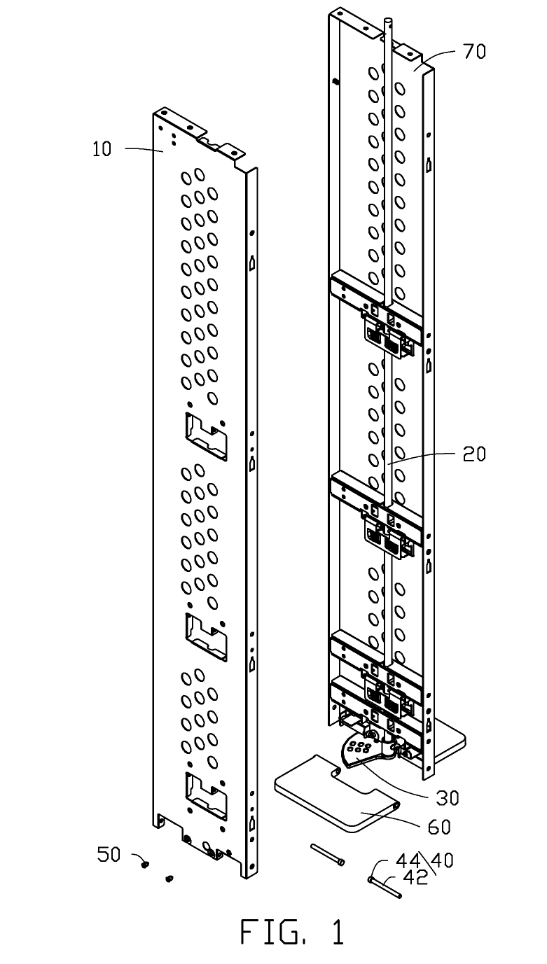

FIG. 1 illustrates one embodiment of a dispensing device. The dispensing device includes a first frame 10, a second frame 70, a rotatable shaft 20, a tray 30, a pair of pivot shafts 40, a pair of limiting members 50, and a base plate 60. The tray 30 is attached to a bottom of the rotatable shaft 20. The base plate 60 can be pivotably attached to each of the first frame 10 and the second frame 70. The tray 30 is rotatable between a first position to support the base plate 60 and a second position where the base plate 60 is released.

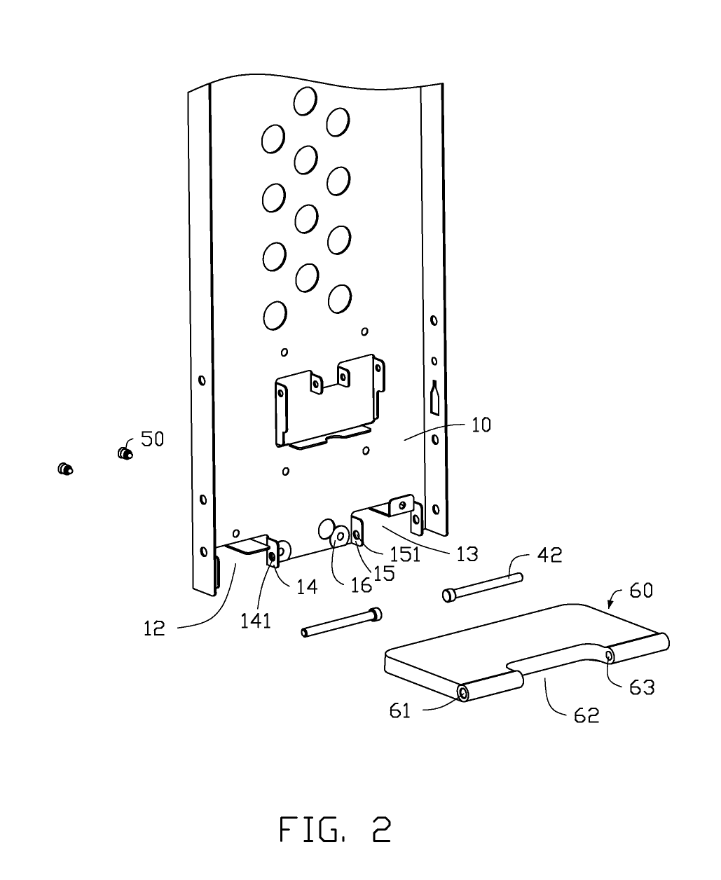

FIG. 2 illustrates the first frame 10 comprising a main plate 11, a pair of first mounting pieces 14 extending substantially perpendicularly from the main plate 11, and a pair of second mounting pieces 15 extending substantially perpendicularly from the main plate 11. A first gap 12 and a second gap 13 are defined in a bottom portion of the main plate 11. The pair of first mounting pieces 14 extends from opposite edges of the first gap 12. The pair of second mounting pieces 15 extends from opposite edges of the second gap 13. The pair of first mounting pieces 14 and the pair of second mounting pieces 15 are substantially parallel to a lengthwise edge of the main plate 11. A pair of securing holes 16 is defined in a lower portion of the main plate 11 and located between the pair of mounting pieces 14 and the pair of second mounting pieces 15. One of the pair of securing holes 16 is located adjacent to an inner one of the pair of first mounting pieces 14. The other one of the pair of securing holes 16 is located adjacent to an inner one of the pair of second mounting pieces 15. An outer one of the pair of first mounting pieces 14 is located adjacent to a left lengthwise edge of the main plate 11. An outer one of the pair of second mounting pieces 15 is located adjacent to a right lengthwise edge of the main plate 11. A first mounting hole 141 is defined in each of the pair of first mounting pieces 14. A second mounting hole 151 is defined in each of the pair of second mounting pieces 15.

FIGS. 1 and 2 illustrate each pivot shaft 40 comprising a rod 42 and a limiting cap 44 connected to one end of the rod 42. A diameter of the limiting cap 44 is greater than that of the rod 42. The diameter of the rod 42 is substantially equal to that of the first and second mounting holes, 141 and 151. A length of the rod 42 is slightly greater than a distance between the pair of first mounting pieces 14 or a distance between the pair of second mounting pieces 15.

FIG. 2 illustrates the base plate 60 comprising a hollow portion 62, a first protruding portion 61, and a second protruding portion 63. The first protruding portion 61 and the second protruding portion 63 are symmetrical around the crosswise mid-line of the base plate 60 and located on either side of the hollow portion 62. A first pivot hole 611 is defined in the first protruding portion 61. A second pivot hole 631 is defined in the second protruding portion 63. The hollow portion 62, the first protruding portion 61, and the second protruding portion 63 are on one lengthwise side of the base plate 60. A length of each of the first pivot hole 611 and the second pivot hole 631 is not greater than the distance between the pair of first mounting pieces 14 or the distance between the pair of second mounting pieces 15. A diameter of each of the first pivot hole 611 and the second pivot hole 631 is substantially equal to the diameter of the first and second mounting hole, 141 and 151.

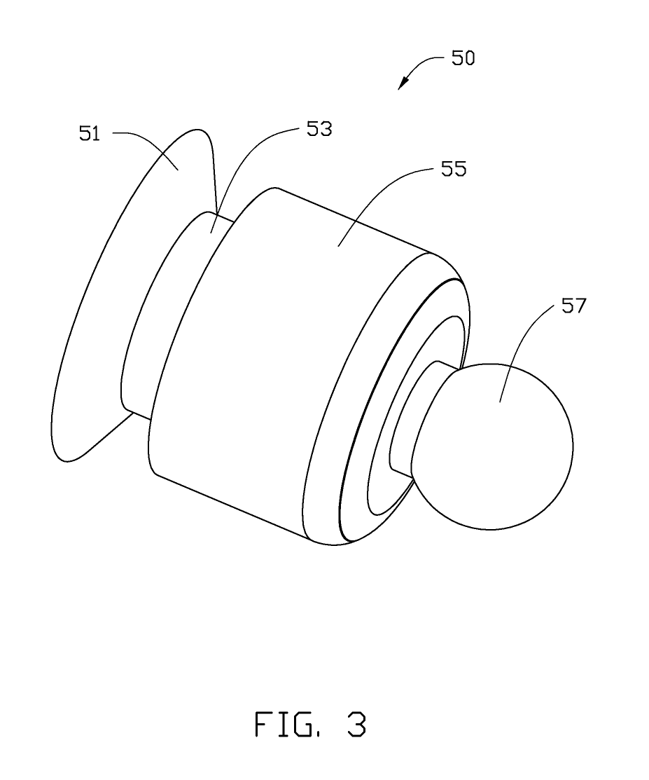

FIG. 3 illustrates each limiting member 50 comprising a base 51, a mounting portion 53 connected to the base 51, a resisting post 55 connected to the mounting portion 53, and a spherical head 57 connected to the resisting post 55. The mounting portion 53 is located between the base 51 and the resisting post 55. The resisting post 55 is located between the mounting portion 53 and the spherical head 57. A cross section of the base 51 is isosceles trapezoid. The mounting portion 53 and the resisting post 55 are cylindrical. A diameter of the resisting post 55 is less than a maximum diameter of the base 51, but greater than the diameter of the diameter of the mounting portion 53. The diameter of the mounting portion 53 is not greater than the diameter of the securing hole 16. A diameter of the spherical head 57 is not greater than the diameter of the mounting portion 53. The limiting member 50 may be hollow, and made of flexible material, such as rubber.

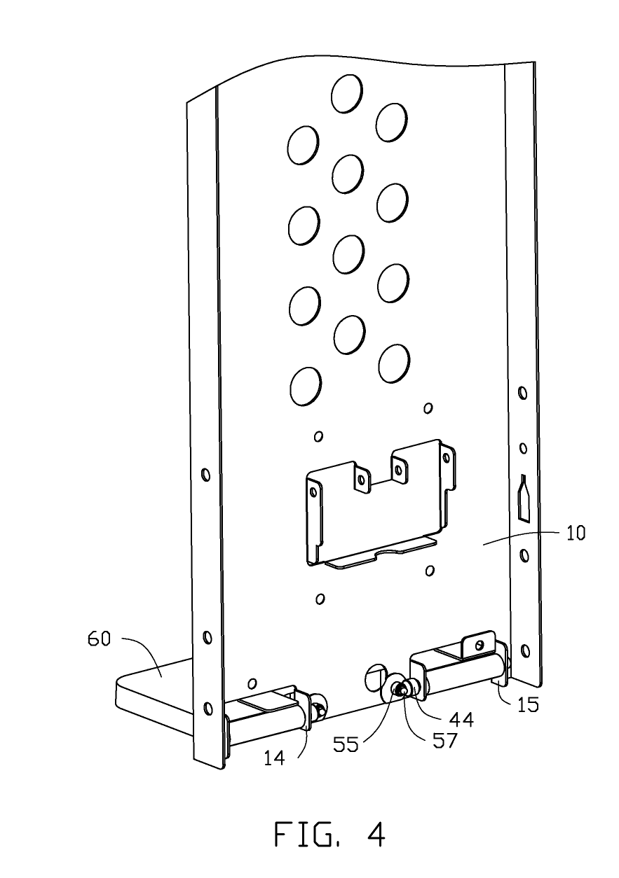

FIG. 4 illustrates assembly of the base plate 60 to the first frame 10, where the first protruding portion 61 is placed in the first gap 12. The second protruding portion 63 is placed in the second gap 13. Two ends of the first pivot hole 611 are aligned with the pair first mounting holes 141. Two ends of the second pivot hole 631 are aligned with the pair of second mounting holes 151. One of the pair of pivot shafts 40 extends through the pair of first mounting holes 141 and the first pivot hole 611. The other one of the pair of pivot shafts 40 extends through the pair of second mounting holes 151 and the second pivot hole 631. Although the limiting cap 44 abuts against the inner one of the pair of first mounting pieces 14 or the inner one of the pair of second mounting pieces 15, the free rotation of the pivot shafts 40 is not impeded. The base plate 60 is pivotably attached to the first frame 10 by the pair of pivot shafts 40. The spherical head 57 extends through the securing hole 16. The resisting post 55 is squeezed into the securing hole 16. After the resisting post 55 extends through the securing hole 16, the resisting post 55 returns to its natural state, and the diameter of the resisting post 55 becomes greater than the diameter of the securing hole 16. The mounting portion 53 is mounted in the securing hole 53, thereby attaching the limiting member to the first frame 10. The resisting post 55 abuts against the limiting cap 44, thereby preventing the pivot shafts 40 from moving out of the first or second mounting holes, 141 or 151 along a direction that is substantially parallel to an axis of the pivot shafts 40.

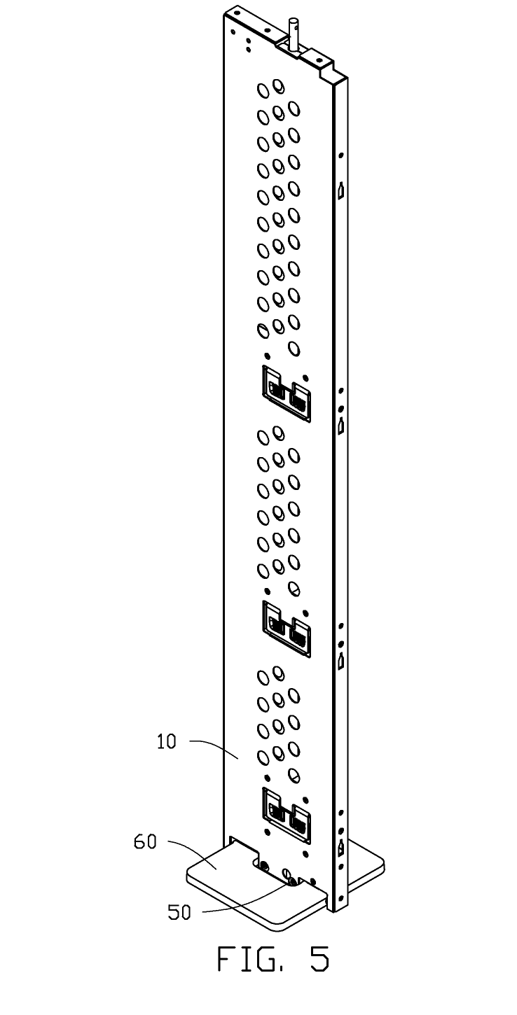

FIG. 5 illustrates during assembly of the first frame 10 to the second frame 70, the first frame 10 being attached to the second frame 70. The rotatable shaft 20 is mounted between the first frame 10 and the second frame 70. In one embodiment, the second frame 70 has substantially the same structure and attachments as those of the first frame 10.

After the dispensing device is assembled, the tray 30 can be rotated between a first position to support the base plate 60, and a second position where the support of the base plate 60 is released. When the base plate 60 is released, the base plate 60 falls down, allowing one product item to drop down for the customer.

Even though numerous characteristics and advantages have been set forth in the foregoing description of embodiments, together with details of the structures and functions of the embodiments, the disclosure is illustrative only and changes may be made in detail, including matters of shape, size, and the arrangement of parts within the principles of the disclosure. The embodiments discussed herein do not limit the following claims.

What is claimed is:

1. A dispensing device, comprising:
a frame comprising a main plate and a pair of mounting pieces extending substantially perpendicularly from the main plate, and a mounting hole defined in each of the pair of mounting pieces;
a base plate comprising a pivot hole;
a limiting member, attached to the main plate, and comprising a resisting post protruding from the frame; and
a pivot shaft comprising a rod, extending though the mounting hole and the pivot hole, and a limiting cap, connected to a distal end of the rod;
wherein an inner side of the limiting cap resists against one of the pair of mounting pieces, and the resisting post resists against an outer side of the limiting cap, thereby preventing the pivot shaft disengaging away from the mounting hole.

2. The dispensing device of claim 1, wherein the limiting member further comprises a base and a mounting portion connected between the base and the resisting post; a securing hole is defined in the main plate, and the mounting portion is mounted in the securing hole.

3. The dispensing device of claim 2, wherein a cross section of the base is isosceles trapezoid, the mounting portion and the resisting post have cylindrical shapes, a maximum diameter of the base is greater than a diameter of the resisting post, the diameter of the resisting post is greater than that of the mounting portion; and the diameter of the mounting portion is not greater than that of the securing hole.

4. The dispensing device of claim 3, wherein the limiting member further comprises a spherical head connected to the resisting post, the base abuts an outer side of the main plate, and the resisting post abuts an inner side of the main plate.

5. The dispensing device of claim 4, wherein the limiting member is flexible and capable of being squeezed into the securing hole.

6. The dispensing device of claim 4, wherein the limiting member is hollow.

7. The dispensing device of claim 1, wherein a gap is defined in a bottom portion of the main plate, and the pair of mounting pieces extends from opposite edges of the gap; and the base plate comprises a protruding portion located in the gap.

8. The dispensing device of claim 7, wherein the pivot hole is defined in the protruding portion and extends along a lateral direction that is substantially perpendicular to the pair of mounting pieces.

9. The dispensing device of claim 8, wherein a length of the pivot hole along the lateral direction is not greater than a distance between the pair of mounting pieces.

10. The dispensing device of claim 9, wherein a length of the rod is greater than the length of the pivot hole along the lateral direction.

11. A dispensing device, comprising:
a frame comprising a pair of mounting pieces, and a mounting hole defined in each of the pair of mounting pieces;
a base plate comprising a pivot hole extending along a lateral direction that is substantially perpendicular to the pair of mounting pieces;
a limiting member, attached to the frame, and comprising a resisting post protruding from the frame; and
a pivot shaft comprising a rod, extending though the mounting hole and the pivot hole along the lateral direction, and a limiting cap, connected to a distal end of the rod;
wherein an inner side of the limiting cap resists against one of the pair of mounting pieces, and the resisting post resists against an outer side of the limiting cap, thereby preventing the pivot shaft disengaging away from the mounting hole.

12. The dispensing device of claim 11, wherein the limiting member further comprises a base and a mounting portion connected between the base and the resisting post; a securing hole is defined in the main plate, and the mounting portion is mounted in the securing hole.

13. The dispensing device of claim 12, wherein a cross section of the base is isosceles trapezoid, the mounting portion and the resisting post have cylindrical shapes, a maximum diameter of the base is greater than a diameter of the resisting post, the diameter of the resisting post is greater than that of the mounting portion; and the diameter of the mounting portion is not greater than that of the securing hole.

14. The dispensing device of claim 13, wherein the limiting member further comprises a spherical head connected to the resisting post, the base abuts an outer side of the main plate, and the resisting post abuts an inner side of the main plate.

15. The dispensing device of claim 14, wherein the limiting member is flexible and capable of being squeezed into the securing hole.

16. The dispensing device of claim 14, wherein the limiting member is hollow.

17. The dispensing device of claim 11, wherein the frame further comprises a main plate, and the pair of mounting pieces extends substantially perpendicularly from the main plate; a gap is defined in a bottom portion of the main plate, and the pair of mounting pieces extends from opposite edges of the gap.

18. The dispensing device of claim 17, wherein the base plate comprises a protruding portion located in the gap, the pivot hole is defined in the protruding portion.

19. The dispensing device of claim 18, wherein a length of the pivot hole along the lateral direction is not greater than a distance between the pair of mounting pieces.

20. The dispensing device of claim 19, wherein a length of the rod is greater than the length of the pivot hole along the lateral direction.
